(19) United States
(12) Patent Application Publication
(10) Pub. No.: US 2017/0081228 A1
(43) Pub. Date: Mar. 23, 2017

(54) Water Treatment System for Preserving Downstream Components

(71) Applicant: Manuel S. Avakian, Rego Park, NY (US)

(72) Inventor: Manuel S. Avakian, Rego Park, NY (US)

(21) Appl. No.: 15/267,499

(22) Filed: Sep. 16, 2016

Related U.S. Application Data
(60) Provisional application No. 62/219,874, filed on Sep. 17, 2015.

(51) Int. Cl. C02F 9/00; C02F 1/28; C02F 1/44

(52) U.S. Cl. CPC C02F 9/005; C02F 1/444; C02F 1/283; C02F 1/441; C02F 2101/12

(57) ABSTRACT

The disclosed technology relates to a water treatment cart including a cart having a base and supports extending upwards from the base; an ultrafiltration system, the ultrafiltration system being attached to the supports with a first mount, the ultrafiltration system removing suspended solids from water down to 0.02 μm in size; and a carbon filtration system, the carbon filtration system being attached to the supports with a second mount, the carbon filtration system removing chloramine, chlorine, and trace organics from the water received from the ultrafiltration system, wherein the ultrafiltration system extends a life span of the carbon filtration system.

### CROSS REFERENCE TO RELATED APPLICATION

This application claims priority to U.S. Provisional Pat. App. Ser. No. 62/219,874 filed on Sep. 17, 2015, which is incorporated by reference in its entirety.

### FIELD OF THE INVENTION

The subject matter described herein relates to a water treatment system for preserving downstream components.

### BACKGROUND

Water plays an important, life-sustaining role for dialysis patients. When hemodialysis started to blossom over 25 years ago, many dialysis centers used water right from the tap. It is now known that certain contaminants in water supplies can cause severe complications in dialysis patients. In fact, no municipal water can be considered safe for use in hemodialysis applications in the absence of a treatment system, since sonic of the most toxic contaminants arise from municipal water treatment practices.

Hemodialysis patients are particularly vulnerable to contaminants in the water used to prepare concentrate and dialysis fluid, or in water used for reprocessing dialyzers. This vulnerability stems from the fact that water is the major constituent of dialysis fluid. Compared with individuals who are not on hemodialysis, hemodialysis patients are exposed to extremely large volumes of water. The estimated water intake of a healthy individual is 2 L per day or 14 L per week. By comparison, during a single dialysis treatment lasting four hours, performed at a dialysis fluid flow rate of 800 mL/min, a hemodialysis patient is exposed to 192 L of water, or to 576 L per week, if treated three times weekly.

Furthermore, hemodialysis patients have inadequate barriers to such contaminants. In healthy individuals who are not on dialysis, the gastrointestinal tract separates blood from contaminants in the water. By comparison, the barrier between blood and water in hemodialysis patients is the membrane within the hemodialyzer through which transfer of contaminants is limited only by the molecular or particulate size of the contaminant. As such, the water used for dialysis patients must be of special quality.

Water purification systems are currently used to purify water to a level determined to be safe for dialysis patients. The critical piece of equipment in these water purification systems is the reverse osmosis (RO) machine, which has proven itself to be the safest, most reliable, and most economical method of purifying water for dialysis.

The Association for the Advancement of Medical Instrumentation (AAMI) has set for water standards as guidelines for dialysis centers to follow. These standards list maximum levels for ions found in water as well as for heavy metals and bacteria. Maximum Allowable Levels (mg/L) as set by the AAMI are as follows: Aluminum 0.01, Arsenic 0,005, Barium 0.1, Cadmium 0.001, Total Hardness 21.0, Calcium 2.0, Calcium as CaC03 5.0, Magnesium 4.0, Magnesium as CaC03 16.0, Chlorine (free) 0.5, Chloramine (combined) 0.1, Chromium 0.014, Copper 0.1, Fluoride 0.2, Lead 0.005, Mercury 0.0002, Nitrate (N) 2.0, Potassium 8.0, Selenium 0.09, Silver 0.005, Sodium 70.0, Sulfate 100.0 and Zinc 0.1.

The current trend is to strive for higher purity for dialysis water while keeping operating cost at a minimum. So, the question remains what is the most reliable and economical way to produce water, which meets or exceeds the AAMI standards?

### SUMMARY

The disclosed technology relates to a water treatment system for preserving downstream components and providing superior water quality.

In one implementation, a water treatment cart unit can, comprise: a cart having base and supports extending upwards from the base; an ultrafiltration system, the ultrafiltration system being attached to the supports with a first mount, the ultrafiltration system removing suspended solids from water down to 0.02 μm in size; and a carbon filtration system, the carbon filtration system being attached to the supports with a second mount, the carbon filtration system removing chloramine, chlorine, and trace organics from the water received from the ultrafiltration system, wherein the ultrafiltration syste extends a life span of the carbon filtration system.

In some implementations, the first mount can be a flush mount rigidly connected to a cylinder mount, the cylinder mount wrapping around an outer portion of the ultrafiltration system and the flush mount mounting to the supports of the cart. In some implementations, the flush mount can be welded to the cylinder mount.

In some implementations, the ultrafiltration system can be communicatively coupled to a water source, hi some implementations, the ultrafiltration system can be communicatively coupled to the carbon filtration system.

In sonic implementations, the carbon filtration system can include a first carbon filter and a second carbon filter. In some implementations, the first carbon filter can be communicatively coupled to the second carbon filter or fixed to a manifold.

In some implementations, the water treatment cart can further comprise: a pump attached to a base of the cart. In some implementations, the first carbon filter can be communicatively coupled to the pump. In some implementations, the pump can be communicatively coupled to a reverse osmosis filtration system.

In some implementations, further comprising: a reverse osmosis filtration system, the reverse osmosis filtration system removing dissolved salts, bacteria, pyrogens and other organic molecules over 200 daltons in molecular weight from the water received from the carbon filtration system, wherein the ultrafiltration system extends the life span of the reverse osmosis filtration system.

The advantage of the disclosed technology is that the water treatment system extends the usable life of carbon filters and RO membranes while providing superior water quality.

### BRIEF DESCRIPTION OF THE DRAWINGS

FIG. 1 is a flow chart showing an implementation of the disclosed technology;

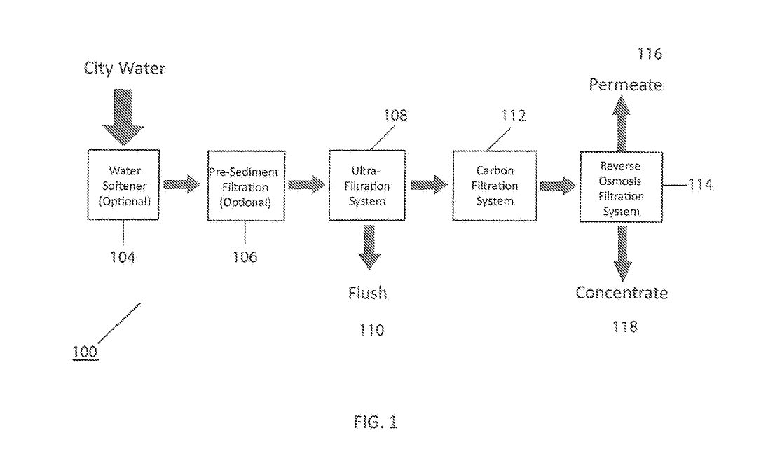

FIG. 2 is a perspective view of an implementation of a water treatment cart of the disclosed technology; and

FIG. 3 is a close-up, rear view of the water treatment cart shown in FIG. 2.

### DETAILED DESCRIPTION

The disclosed technology relates to a water treatment system for purifying a water source for dialysis treatments while preserving the life span of downstream filtration system components.

Conventional water purification systems purify water to acceptable levels as set by AAMI but higher purity water for dialysis treatments is constantly being sought. Also, the cost associated with maintaining these conventional water purification systems is high. The cost can be attributed to the replacement and maintenance of the carbon filters and RO membranes. For example, a typical carbon block system must be changed after three months, or in some cases after 7-10 treatments. The RO membranes are replaced after decreased flow product and AAMI chemical analysis indicating unacceptable levels of tested chemicals. The disclosed technology has developed a system that preserves the life span of the carbon filters and the RO membrane by removing suspended solids down to 0.02 μm (micron) in size before the water is fed into the carbon filters and the RO membranes.

The water treatment system 100 can include an ultrafiltration system 108, a carbon filtration system 112 and a reverse osmosis filtration system 114. In some implementations, a pre-sediment system 106 and a water softener system 104 can also be utilized depending on the quality of the water source.

The ultrafiltration system 108 can include an ultrafiltration membrane that provides a physical barrier for the suspended solids and removes particulate from the water source down to approximately 0.02 μm (micron).

These ultrafiltration systems, however, do not remove ions or other elemental forms such as hardness and heavy metals, or small organic molecules such ss pesticides.

The advantage of the ultrafiltration system, is that the pre-treated water does not contain suspended solids larger than 0.02 μm, which in tarn puts less stress on the carbon filtration system 112 and the reverse osmosis filtration system 114. Therefore, these carbon filters and RO membranes will have their life significantly increased. For example, the carbon filer system 112 can provide filtration for 100 treatments—a ten-fold increase from conventional systems—while the RO membranes are replaced after a AAMI chemical analysis indicating unacceptable levels of chemicals—also a ten-fold increase from conventional systems.

Additionally, the ultrafiltration system 108 can be a backwashable filter that can be flushed periodically (e.g., before each use), allowing the feed water to flush any particulate that has been retained on the ultrafiltration membrane to drain. In some implementations, the ultrafiltration system can have an automated cleaning function set for cleaning the filter after each use. The ultrafiltration system needs replacement when a decreased post ultrafilter pressure indicates decreased product not resolved by cleaning the ultrafilter. Typically, ultrafilters have been providing superior filtration for over 3 years without a significant decrease in function.

Carbon filters can be used to remove the chlorine and chloramine compounds by chemically reacting with them. The chlorine and chloramine are converted to chloride, while the carbon is converted to carbon dioxide. Incoming water passes over the granular activated carbon media inside the tank then flows up through a. tube in the center. During this process, the carbon filter bed does not have to filter any fine sediment. silt, organics and/or dirt, as these were removed prior from the water enter the carbon

The reverse osmosis filtration removes both organic molecules and salt ions from the water. In use, a RO membrane sieves organic molecules and repels salt ions while passing pure water through the micropores the RO membrane surface. The driving force behind RO is pressure, which is typically supplied by a centrifugal pump. This pressure is needed to overcome the inherent osmotic pressure of the solution and to supply enough energy to force water through membrane pores, which are only approximately 5 angstroms in diameter.

The basic components of an RO system 114 can be the prefilter, a pump, and sepralators (spiral-wound membrane elements). The sepralators are placed in stainless steel or PVC housings, which are then manifolded together. RO systems 114 operate in a crossflow mode, whereby a single stream is fed into the RO and flows across the membrane surface. Two streams exit—the permeate 116 and the concentrate 118. The permeate stream contains the water which passes through the membrane and is purified. The concentrate stream contains the water. salt ions, and organic molecules that do not pass through the membrane; the concentrate is typically plumbed to drain.

The advantage of operating in the crossflow mode is that it to plugging of the very small membrane pores. However, as a result of crossflow operation, only a percentage of the feed is collected as permeate.

In some implementations, the RO permeate 116 can be fed directly into a loop, which serves the dialyzers. This minimizes stagnant areas where bacteria can establish. In some implementations, the concentrate 118 can be recirculated, back to the inlet of the RO. This lowers the feed water dissolved solids level, thus providing an even higher quality permeate.

In use, tap water is fed into an ultrafiltration system 108. The ultra filtration system 108 removes particulate, down to 0.02 μm (micron) in size. These systems, however, do not remove ions or other elemental forms such as hardness and heavy metals, or small organic molecules such as pesticides. The ultrafiltration system 108 can he flushed periodically in the forward direction by the opening of the solenoid drain valve allowing the flush 110 to exit the ultrafiltration system 108. This allows the feed water to flush the particulate that has been retained on the membrane surface to drain. In some implementations, a 100-200 μm pre-sediment filter, a backwashable sand filter, can be utilized upstream to screen out large particulate, if present. in some implementations, a water softener can also he utilized upstream to remove calcium and magnesium ions.

The treated water from the ultrafiltration system 108 can then he fed to activated carbon tanks 112, employed in series, to remove chloramine, chlorine, and trace organics. It is important to keep the chloramine or chlorine in the system up to this point in order to minimize the chance of bacterial growth.

Next comes the RO machine 114, which typically removes 90% to 95+ % of the dissolved salts. RO also removes bacteria and pyrogens as well as 99+ % of organic molecules over 200 daltons in molecular weight.

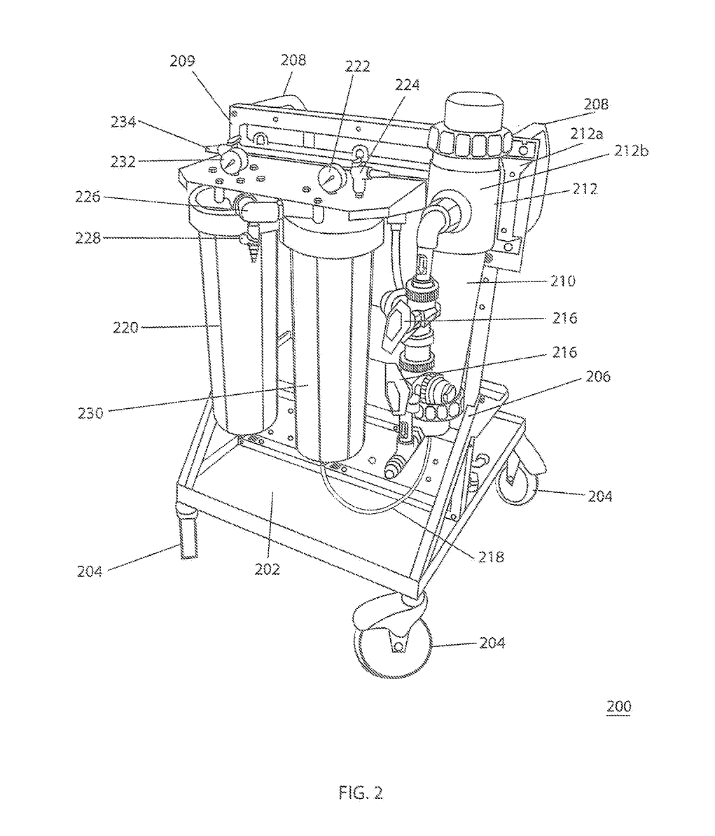

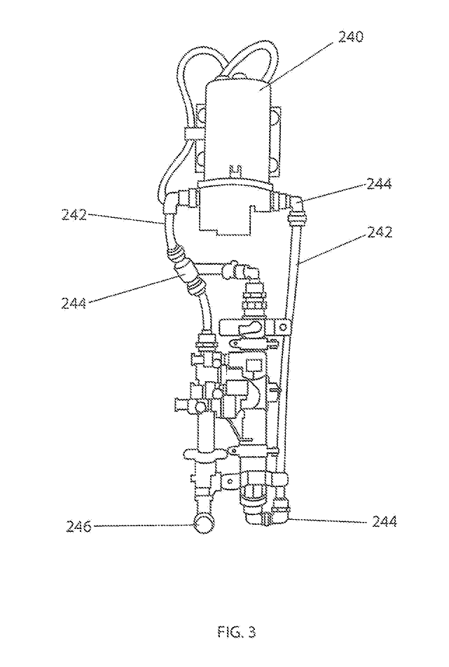

FIGS. 2 and 3 show a water filtration cart 200 employing a portable ultrafilter 210 and two carbon filters 220, 230. This cart 200 can be easily transported and attached to an incoming water source and an RU machine (not shown) in different locations throughout a hospital, home or some other facility.

In some implementations, the dimensions of the cart 200 can be 24″W×21″D×42″H. This design uses two 4″Ø×20″ carbon blocks and one 4″Ø×20″ ultrafilter with Stainless Steel body and all stainless steel fittings on a custom mountings. in other implementations, the cart 200 can have a smaller footprint for easier access in between patient beds. This design has a cart 200 with dimensions of 16.5″W×20″D×42″H. This is also an all stainless steel construction, using two 2.5″Ø×20″ carbon blocks and one 4″Ø×20″ ultrafilter with a stainless steel body and all stainless steel fittings on a custom mountings. Both designs can use a WRO300H model reverse osmosis system without compromising the flow or the quality of the product water for the patient (0.02 um). The advantages of such a system are extended life of filters, excellent membrane cleanability, no additional equipment is required to clean and low OPEX for chemicals.

The cart 200 also can have a base 202 with caster wheels 204 attached to a bottom thereof. The cart 200 also has supports 206 extending above the base 202 for holding the carbon filters 220, 230 and the ultrafilter 210. The cart 200 can also have handles 208 extending laterally from a top portion of the base supports 206.

The ultrafilter 210 can be attached to the base supports 206 with a mount 212 that surrounds and supports a top portion of the ultrafilter 210 and a rear mount 214 that firmly secures the ultrafilter 210 to the base support 206. The mount 212 includes a flush mount 212a piece rigidly connected to a cylinder mount 212b. The cylinder mount 212b wraps around an outer portion of the ultrafilter 210, while the flush mount 212a mounts to the supports of the cart with nuts and bolts.

The ultrafilter 210 can further include bypass valves 216 used for directing the water flow into a dump, flush or filter positions, The ultrafilter 210 can be communicatively attached to a first carbon filer with tubing 218.

The first carbon filter 220 can be mounted to a horizontal support 209 extending from the base supports 206. On the top surface of the horizontal supports 209 a pressure meter 222 can be mounted for viewing internal pressures of the first carbon filter 220 along with a sample port 224 for measuring the quality of the water in the first carbon filter 220.

The second carbon filter 230 can also be mounted to the horizontal support 209 having a pressure meter 232 and sample port 234 located thereon. The first and second carbon filters 220, 230 can be communicatively coupled with a bent PVC pipe 226 having a sample port 228 located between the two filters.

The second carbon filer 230 can have a connection for being communicatively coupled to a pump 240 for supplying the water to a RO machine (not shown). The pump 240 can be a high-flow, low-pressure delivery pump located on the base 202 and having tubing 242, fittings 244 and connectors 246 for supplying pressurized treated water to the RO machine.

The disclosed technology preserves the life span of the carbon filters by removing suspended solids down to 0.02 μm (micron) in size before the low particulate water is fed into the carbon filters thereby extending the life of the carbon filters.

The foregoing Detailed Description is to be understood as being in every respect illustrative and exemplary, but not restrictive, and the scope of the disclosed technology disclosed herein is not to he determined from the Detailed Description, but rather from the claims as interpreted according to the full breadth permitted by the patent laws. It is to be understood that the embodiments shown and described herein are only illustrative of the principles of the disclosed technology and that various modifications may be implemented by those skilled in the art without departing from the scope and spirit of the disclosed technology. Those skilled in the art could implement various us other feature combinations without departing from the scope and spirit of the disclosed technology. Although the embodiments of the present disclosure have been described with specific examples, it is to be understood that the disclosure is not limited to those specific examples and that various other changes, combinations and modifications will be apparent to one of ordinary skill in the art without departing from the scope and spirit of the disclosed technology which is to be determined with reference to the following claims.

1. A water treatment cart unit comprising:
a cart having a base and supports extending upwards from the base;
an ultrafiltration system, the ultrafiltration system being attached to a manifold with a first mount, the ultrafiltration system removing suspended, solids from water down to 0.02 μm in size; and
a carbon filtration system, the carbon filtration system being attached to the manifold with a second mount, the carbon filtration system removing chloramine, chlorine, and trace organics from the water received from the ultrafiltration system,
wherein the ultrafiltration system extends a life span of the carbon filtration system.

2. The water treatment cart unit of claim 1 wherein the first mount is a flush mount connected to a cylinder mount, the cylinder mount wrapping around an outer portion of the ultrafiltration system and the flush mount mounting to the supports of the cart.

3. The water treatment cart unit of claim 2 wherein the flush mount is welded to the cylinder mount.

4. The water treatment cart unit of claim 1 wherein the ultrafiltration system is communicatively coupled to a pump.

4. The water treatment cart unit of claim 4 wherein the ultrafiltration system is communicatively coupled to the carbon filtration system.

6. The water treatment cart unit of claim 5 wherein the carbon filtration system includes a first carbon filter and a second carbon filter.

6. The water treatment cart unit of claim 6 wherein the first carbon filter is communicatively coupled to the second carbon filter.

8. The water treatment cart unit of claim 1 wherein the second mount is a horizontal mount being fixedly connected to the supports of the cart.

9. The water treatment cart unit of claim 8 further comprising;
a pump being attached to a base of the cart.

10. The water treatment cart unit of claim 9 wherein the second carbon filter is communicatively coupled to the pump, the pump being coupled to a water source.

11. The water treatment cart unit of claim 10 herein the pump is communicatively coupled to a reverse osmosis filtration system.

12. The water treatment cart unit of claim 1 further comprising:
a reverse osmosis filtration system, the reverse osmosis filtration system removing, dissolved salts, bacteria, pyrogens and other organic molecules over 200 daltons in molecular weight from the water received from the carbon filtration system,
wherein the ultrafiltration system extends a life span of the reverse osmosis filtration system.
